(19) United States
(12) Patent Application Publication
(10) Pub. No.: US 2008/0053373 A1
(43) Pub. Date: Mar. 6, 2008

(54) Coating Installation Suitable For Clean Room Conditions

(75) Inventors: Dietrich Mund, Obersussbach (DE); Wolfgang Fukarek, Fischbach bei Arnsdorf (DE); Jurgen Leib, Freising (DE)

Correspondence Address: DEMONT & BREYER, LLC, 100 COMMONS WAY, Ste. 250, HOLMDEL, NJ, 07733, US

(73) Assignee: SCHOTT AG, 55122 Mainz (DE)

(21) Appl. No.: 11/572,252

(22) PCT Filed: Jul. 14, 2005
(86) PCT No.: PCT/EP05/07652

§ 371 Date: Aug. 2, 2007

(30) Foreign Application Priority Data
Jul. 21, 2004 (DE) 10 2004 035 335.2

(51) Int. Cl. B05C 11/00

(52) U.S. Cl. 118/666

(57) ABSTRACT

At least one shielding device, which protects the vacuum chamber walls and/or the components arranged in the chamber from undesired deposits of the layer starting material is arranged in the vacuum chamber of a coating installation according to the invention in which vitreous, glass-ceramic and/or ceramic layers are applied to substrates by deposition from the gas phase. It is important that in the event of temperature changes in the vacuum chamber, the expansion or contraction of the shielding device corresponds to the expansion or contraction of the vitreous, glass-ceramic or ceramic layer or deposits.

The invention relates to a vacuum coating installation for vapour deposition processes, in particular for coatings of vitreous, glass-ceramic or ceramic materials, which has a shielding device in the vacuum chamber in order to prevent undesirable layer deposits in the vacuum chamber and to prevent these deposits from becoming detached, flaking off, etc. This coating installation is therefore particularly suitable for clean room technologies.

Vapour deposition processes (deposition of layers from the vapour phase) form an essential part of the production of modern products in virtually all sectors of industry. Development, for example in optical, optoelectronic or semiconductor technology, is being driven by ever smaller structures, higher functionality, higher productivity and higher quality demands.

In this context, layers of inorganic materials, in particular of vitreous, glass-ceramic or ceramic materials, are used for a very wide range of applications.

By way of example, processes for passivation, encapsulation and production of patterned layers on substrates by means of vitreous coatings have been developed for implementing modern technologies in optics, optoelectronics, MEMS applications and semiconductor technology (SCHOTT patent applications DE 102 22 964 A1; DE 102 22 958 A1; DE 102 22 609 A1).

Fundamentally different techniques are suitable for the deposition of vitreous, glass-ceramic or ceramic layers, such as for example CVD (chemical vapour deposition) processes, or PVD (physical vapour deposition) processes. The choice of a suitable process is dictated both by the coating material, the required coating rates, demands imposed on the coating quality, but also in particular by the thermal stability of the substrate.

Since the substrates that are to be coated, such as for example integrated circuits on silicon wafers, are often temperature-sensitive, suitable processes are predominantly those which allow coating at below 120° C. PVD processes, in particular electron beam vaporization, have proven to be suitable processes for the coating of temperature-sensitive substrates with a glass or glass-ceramic layer, since the vitreous, glass-ceramic or ceramic layers can be vaporized at high coating rates and with a high purity and then deposited as vitreous multi-component layers.

Corresponding coating processes and installations are known, inter alia, from the documents cited above.

Undesirable deposits of the vitreous, glass-ceramic or ceramic layer material in the vacuum chamber and on installation parts contained therein have been found to restrict the use of this coating technology. After the coating process, these deposits become detached during cooling of the installation and during opening of the vacuum chamber, forming extremely small particles, and lead to contamination of the substrates, the chamber and the surrounding area. The accumulation of water molecules from the ambient air accelerates the delamination process considerably when the chamber is opened.

Since microstructured and microelectronic components generally have to be produced under clean room conditions, the coating with vitreous, glass-ceramic or ceramic layers cannot be carried out in clean rooms using conventional coating installations. If the coating takes place outside a clean room, complex procedures for cleaning the chamber and the substrates are required each time the vacuum chamber is opened.

It is known to use linings, for example of aluminum foil, to avoid the undesirable deposition of layer materials on chamber walls and the installation parts located in the chamber. However, in this case too, delamination of the layer from the shields or linings occurs as a result of temperature changes and inadequate bonding of the layer materials to the linings or shields.

To avoid the detachment of particles caused by temperature differences, it is known, for example from EP 0 679 730 B1, to match the temperature of the shielding device to that of the material applied by sputtering by heating the shielding device.

Although this substantially prevents the chamber and the substrates from being contaminated by detached particles during the coating operation, it is not possible to prevent particles from flaking off when the chamber is opened, thereby contaminating the coating installation and the surrounding room.

Therefore, the object of the invention is to protect the specimen/vacuum chamber and its components from undesirable layer deposits and to avoid contamination of the substrates and the vacuum chamber and its surrounding area. A further object of the invention is that of allowing conventional coating installations to be used for coatings with vitreous, glass-ceramic or ceramic materials under clean room conditions.

According to the invention, to achieve this object, at least one shielding device, which protects the vacuum chamber walls and/or the components arranged in the chamber from undesirable deposits of the layer starting material, is arranged in the vacuum chamber of a coating installation in which vitreous, glass-ceramic and/or ceramic layers are applied to substrates by deposition from the vapour phase. It is important that in the event of temperature changes in the vacuum chamber, the expansion or contraction of the shielding device, at least in the regions with deposits of the layer starting material, corresponds to the expansion or contraction of the vitreous, glass-ceramic or ceramic layer or deposits.

Typical layer thicknesses for hermetic encapsulation or the microstructuring of semiconductors, optical micro-components, MEMS, optoelectronic components, etc. with vitreous, glass-ceramic or ceramic layers are within the range between 0.01 μm and 100 μm. This accordingly leads to correspondingly “thick” and brittle, vitreous deposited layers on the shielding device. A coating installation according to the invention, by virtue of the shielding device, prevents these layers from being deposited on parts of the installation, and the shielding device prevents the formation of stresses between the shielding device and the deposited layer in the event of temperature changes, with the result that delamination and consequently contamination by detached layer particles is avoided.

This is preferably possible firstly if the shielding device has the same expansion coefficient as the vitreous, glass-ceramic or ceramic layer which is to be applied to the substrate, although minor deviations between the expansion coefficients are also possible. The permissible deviation is ultimately determined by the stresses which occur between the shielding device and the layer in the event of temperature changes and must remain below a level at which delamination could occur.

It is preferable for the shielding device to consist of a vitreous, glass-ceramic or ceramic material, in particular of the same material as the layer which is to be applied, since in this case both the shielding device and the layer have approximately the same, preferably exactly the same, expansion coefficient.

Coating installations which are suitable for clean room applications are required in particular for the coating of wafers for the production of electronic and optoelectronic components. The coating of these components, for example for encapsulation, chip-size packaging, wafer-level packaging etc., requires vitreous, glass-ceramic and/or ceramic layers which function as passivation layers and diffusion barriers. In addition, special components have to be transparent and/or have a long lifetime. A layer material which is particularly suitable for vapour deposition processes is borosilicate glass, for example SCHOTT glass No. 8329 or No. G018-189.

Shielding devices which likewise comprise borosilicate glass are advantageously suitable for coatings of this type.

On the other hand, according to a further advantageous configuration of the invention, in which the expansion or contraction of the shielding device in the regions on which vitreous, glass-ceramic or ceramic layer deposits are to be found corresponds to the expansion or contraction of the layer, the shielding device comprises a polymer film which is resistant to high vacuum and is thermally stable.

The vitreous, glass-ceramic or ceramic layer deposits which are formed on the film during the coating operation determine the contraction or expansion of the elastic film, which follows the contraction or expansion of the layer which is present thereon, so that there can be no delamination in the event of temperature changes.

Suitable films include inorganic films, such as polymer films of polyester or polyimide, for example Mylar films or Kapton films.

To protect both the chamber inner walls and components arranged in the chamber, such as substrate holders, shutters, etc., it is advantageous for the shielding device to be of multi-part design. By way of example, the chamber inner walls may be protected by partitions made from glass elements, the substrate holder may be protected by a covering of glass with corresponding cutouts for the substrate, and other components may be protected by suitably adapted coverings made from glass.

It is also conceivable to cover the components with film and to line the inner walls with film, or to use a combination of shielding elements, for example a substrate holder shield made from glass or glass-ceramic and chamber inner wall shields made from polymer film.

According to a further advantageous embodiment of a coating installation according to the invention, the layer starting material in the form of a target can be vaporized by means of electron beam vaporizers for the deposition of a vitreous, glass-ceramic or ceramic layer from the vapour phase.

As a result, by way of example, insulation layers for microelectronic components can be deposited using a suitable glass material by PVD coating or by deposition on a substrate. This is particularly advantageous in particular because it leads to only moderate thermal loading of the substrate. The deposition of glass layers by electron beam vaporization, in particular by plasma ion assisted electron beam deposition, allows the production of very thin, homogeneous insulation layers.

Layer starting materials formed from borosilicate glass targets, for example from SCHOTT glass No. 8329 or No. G018-189, can be vaporized by electron beam vaporization in such a way as to form a glass layer or vitreous layer on the surface of a substrate which faces the vaporization source and is exposed to the vapour emitted by the source (target). This property is not fulfilled by all glass materials. With many glass materials, glass layers or vitreous layers are not formed, but rather merely non-vitreous oxide layers are deposited, and these generally no longer have good encapsulation and/or radiofrequency properties.

Particularly suitable glass materials which can be vaporized and deposited again as vitreous or glass layers are glasses which comprise at least a binary materials system. Glass layers which have been deposited by vaporization of glasses of this type have particularly good encapsulation and radiofrequency properties, on account of their low level of defects.

In a further suitable embodiment of the coating installation, the substrate holder is designed to receive a plurality of substrates, in particular to receive a plurality of wafers that are to be coated. This allows the production of microstructured components to be carried out even more effectively.

The efficiency of the installation is also significantly improved by a separately evacuable load-lock chamber for feeding the substrates into the evacuated vacuum chamber and removing the coated substrates from the evacuated vacuum chamber, since the vacuum chamber does not have to be opened and evacuated again for each change of substrates.

The load-lock technique can be used to transport a plurality of substrates which are located in a cartridge system from a clean room, via the lock chamber, directly into the coating installation and back again.

Since the shielding device according to the invention prevents contamination of the vacuum chamber, the coating operation can be carried out with repeated change of substrates until the stock of target has been completely used up. This allows the efficiency of the installation to be increased still further.

To reduce the contamination of a clean room from which the substrates are transported into the vacuum chamber and back out of it still further, the vacuum chamber preferably has at least one maintenance opening for cleaning the vacuum chamber and/or replacing the shielding device and/or changing the target, and the maintenance opening can be opened not toward the clean room but rather toward a grey room area which is separate from the clean room.

The invention is explained in more detail below on the basis of an exemplary embodiment. In the drawing:

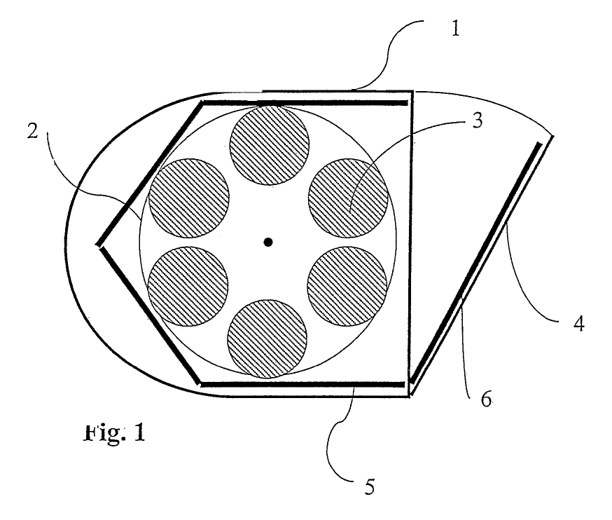

FIG. 1 diagrammatically depicts a vacuum chamber with chamber inner wall shields.

The invention is explained on the basis of an electron beam coating installation in which substrates, for example silicon wafers, are coated with a microstructured glass layer. Further details on the production and patterning of glass layers of this type are disclosed, for example, in DE 102 22 964 A1, DE 102 22 958 A1 and DE 102 22 609 A1.

The vaporization of the layer starting material in the form of a glass target formed from SCHOTT glass No. 8329 (glass 1) or SCHOTT glass No. G018-189 (glass 2) is carried out in the vacuum chamber (1), illustrated in FIG. 1, of the coating installation (not shown) by means of an electron beam, with the glass vapour being deposited on the wafers (3) arranged on a substrate holder (2), and the condensed layer on the substrate surface additionally being densified by plasma ion bombardment (PIAD).

In the process, vitreous layers with layer thicknesses of from 0.1 to 100 μm having the following properties are deposited on the substrate surface:

| | Glass 1 | Glass 2 |
|---|---|---|
| Chemical composition | | |
| Li₂O | 0.1-1% | 0.1-1% |
| B₂O₃ | 10-50% | 10-50% |
| Na₂O₃ | 1-10% | 0.1-1% |
| Al₂O₃ | 1-10% | 0.1-1% |
| SiO₂ | >50% | >50% |
| K₂O | 0.1-1% | 0.1-1% |
| α₂₀₋₃₀₀ [10⁻⁶K⁻¹] | 2.75 | 3.2 |
| Density (g/cm³) | 2.201 | 2.12 |
| Transformation point [° C.] | 562° C. | 742 |
| Refractive index | n_{D} = 1.469 | 1.465 |
| Hydrolytic resistance class in | HGB 1 | HGB 2 |
| accordance with ISO 719 | | |
| Acid resistance class in | 0.6 | 2 |
| accordance with DIN 12 116 | | |
| Alkali resistance class in | | 3 |
| accordance with DIN 52322 | | |
| Dielectric constant ε (25° C.) | 4.7 | 3.9 |
| | (1 MHz) | (40 GHz) |
| tanδ (25° C.) | 45 * 10⁻⁴ | 26 * 10⁻⁴ |
| | (1 MHz) | (40 GHz) |

A multi-part shielding device comprising panes of borosilicate glass is located in the vacuum chamber (1) for protecting the chamber inner walls. The shielding device comprises four panes (5), which are set up in front of the chamber inner walls in the vacuum chamber (1), and a glass pane (6) secured to the chamber door (4). The four panes (5) can be secured to the floor and/or the ceiling of the vacuum chamber (1) by holding means and/or guide rails. When the chamber door (4) is closed, the glass panes (5, 6) completely protect the chamber inner walls from undesired layer deposits. In addition, the substrate holder (2) can be covered by a borosilicate glass pane (not shown). This has the same diameter as the substrate holder (2) and circular cutouts for the wafers (3), and is secured to the substrate holder (10).

1. Coating installation for the deposition of at least one of vitreous layers, glass-ceramic layers, and ceramic layers from the vapour phase on substrates, which installation has at least one vacuum chamber (1), in which at least the following components are arranged:
at least one substrate holder (2),
at least one device for providing at least one layer starting material, and
at least one shielding device for protecting at least one of (i) the vacuum chamber inner walls and (ii) components arranged in the chamber from undesirable deposits of the vaporized layer starting material,
wherein in the event of temperature changes in the vacuum chamber (1),
the expansion or contraction of the shielding device
at least in regions of the shielding device with deposits of the vaporized layer starting material,
corresponds to the expansion or contraction of the layer, characterized in that the shielding device comprises a polymer film.

2. Coating installation according to claim 1, characterized in that the shielding device has the same expansion coefficient as the layer which is to be applied to the substrate.

3. Coating installation according to claim 1, characterized in that the shielding device comprises at least one of a vitreous material, glass-ceramic material, and ceramic material.

4. Coating installation according to claim 1, characterized in that the material of the shielding device corresponds to the material of the applied layer.

5. Coating installation according to claim 1, characterized in that the shielding device comprises a polymer film which is resistant to high vacuum and is thermally stable.

6. Coating installation according to claim 5, characterized in that the shielding device comprises one of (i) a polyester polymer film and (ii) a polyimide polymer film.

7. Coating installation according to claim 1, characterized in that the shielding device is of multi-part design.

8. Coating installation according to claim 7, characterized in that the shielding device comprises parts made from at least one of a vitreous material, glass-ceramic material, and ceramic material, and parts made from polymer film which is resistant to high vacuum and is thermally stable.

9. Coating installation according to claim 8, characterized in that a part of the shielding device made from at least one of a vitreous material, glass-ceramic material, and ceramic material is a substrate holder shield, and parts of the shielding device made from polymer film which is resistant to high vacuum and is thermally stable are chamber inner wall shields.

10. Coating installation according to claim 1, characterized in that it has means for feeding the layer starting material in gaseous form into the vacuum chamber.

11. Coating installation according to claim 1, characterized in that it has means for converting the layer starting material into the gas phase.

12. Coating installation according to claim 11, characterized in that the layer starting material comprises a target arranged in the vacuum chamber.

13. Coating installation according to claim 12, characterized in that the target comprises one of (i) a multi-component glass and (ii) a multi-component glass-ceramic.

14. Coating installation according to claim 13, characterized in that the target comprises a borosilicate glass.

15. Coating installation according to claim 11, characterized in that the means for converting the layer starting material into the vapour phase comprise means for one of electron beam vaporization, thermal vaporization, and pulsed plasma ion beam vaporization.

16. Coating installation according to claim 1, characterized in that it has means for densifying the layer which has been deposited on the substrate.

17. Coating installation according to claim 16, characterized in that the densifying means comprise means for plasma ion assisted deposition.

18. Coating installation according to claim 1, characterized in that the vacuum chamber (1) has a substrate holder (2) for a plurality of substrates that are to be coated.

19. Coating installation according to claim 18, characterized in that the vacuum chamber (1) has a substrate holder (2) for a plurality of wafers (3) that are to be coated.

20. Coating installation according to claim 1, characterized in that it has a separately evacuable load-lock chamber for feeding the substrates into the evacuated vacuum chamber (1) and removing the coated substrates from the evacuated vacuum chamber (1).

21. Coating installation according to claim 20, characterized in that the lock chamber connects the vacuum chamber (1) to a clean room.

22. Coating installation according to claim 20, characterized in that the vacuum chamber (1) has at least one maintenance opening for Performing at least one of cleaning the vacuum chamber (1), replacing the shielding device, and changing the target.

23. Coating installation according to claim 22, characterized in that the maintenance opening connects the vacuum chamber (1) to a grey room area which is separate from the clean room.
